(19) United States
(12) Patent Application Publication
(10) Pub. No.: US 2008/0232202 A1
(43) Pub. Date: Sep. 25, 2008

(54) APPARATUS AND METHOD OF REPRODUCING WOBBLE SIGNAL

(75) Inventor: Dae-hoon KWON, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/835,654

(22) Filed: Aug. 8, 2007

(30) Foreign Application Priority Data
Mar. 20, 2007 (KR) 2007-27273

(51) Int. Cl. G11B 7/00

(52) U.S. Cl. 369/44.13

(57) ABSTRACT

An apparatus for reproducing a wobble signal, including: a first filter unit receiving a wobble signal obtained by reading a wobble from a disc and passing a first band including a monotone frequency set according to the type or speed of the disc so as to generate a first wobble output signal; a second filter unit, when the wobble signal includes at least one frequency component, receiving the wobble signal and passing a second band including a multi-frequency set according to the speed of the disc so as to generate a second wobble output signal; and a wobble clock signal generation unit generating a wobble clock signal by quantizing one of the first and second wobble output signals. Accordingly, the wobble signal can be detected according to the type of disc, the speed of a disc, or a driving mode for the disc.

### CROSS-REFERENCE TO RELATED APPLICATION

This application claims the benefit of Korean Application No. 2007-27273, filed Mar. 30, 2007 in the Korean Intellectual Property Office, the disclosure of which is incorporated herein by reference.

### BACKGROUND OF THE INVENTION

1. Field of the Invention

Aspects of the present invention relate to an optical recording and/or reproducing apparatus, and more particularly, to an apparatus and a method of reproducing a wobble signal from an optical disc.

2. Description of the Related Art

Optical discs are classified into read-only discs (such as CD (compact disc)-ROM (read only memory), DVD (digital versatile disc)-ROM), write-once discs (such as CD-R (recordable), DVD-R), and rewritable discs (such as CD-RW (rewritable), DVD-RW, DVD-RAM (random access memory)). New format discs (such as a high-capacity Blu-ray disc (BD), HD (high definition)-DVD) have appeared and are being used of late.

In contrast with existing read-only discs, rewritable discs are unable to generate a channel clock signal from a reproduction signal. More specifically, a disc has grooves on which data is written and are wobbled for a predetermined period of time. A wobble signal is detected from the wobbled grooves so as to thereby generate a channel clock signal which is required upon writing.

A write clock identical with a disc rotation speed can be generated due to the wobbling, and can represent information about location and characteristics of the disc. More specifically, by multiplying the detected wobble signal by a predetermined number, the write clock identical with the disc rotation speed is generated and is used to write data. A wobble phase locked loop (PLL) can stably generate a clock signal having the same frequency and phase as those of the wobble signal.

FIG. 1 is a block diagram of a conventional wobble signal reproducing apparatus 10. Referring to FIG. 1, the conventional wobble signal reproducing apparatus 10 includes first and second adders 111 and 112, first and second high pass filters (HPFs) 121 and 122, first through third automatic gain controllers (AGCs) 131, 132, and 160, a subtractor 140, a band pass filter (BPF) 150, and a comparator 170.

Quantities of light measured from areas A, B, C, and D on a disc type photo detector are input to the first and second adders 111 and 112. The first adder 111 adds the quantities of light measured from the areas A and D on the disc (i.e., a left half of the detector) to thereby generate an A+D signal. The second adder 112 adds the quantities of light measured from the areas B and C on the disc (i.e., the right half of the detector) to thereby generate a B+C signal. Each of the A+D signal and the B+C signal includes an in-phase radio frequency (RF) signal and an opposed-phase wobble signal.

The A+D signal and the B+C signal are filtered by the first and second HPFs 121 and 122, respectively, which have such cut-off frequencies as to allow wobble signals to pass therethrough. Therefore, DC offsets are removed from the A+D signal and the B+C signal by the first and second HPFs 121 and 122. The high pass filtered A+D signal and the high pass filtered B+C signal are input to the first and second AGCs 131 and 132, respectively, and controlled so that the RF signals included therein have constant amplitudes. Thus, leakage of the RF signals by the wobble signals is prevented. The subtractor 140 subtracts the A+D signal and the B+C signal output by the first and second AGCs 131 and 132 so as to remove the in-phase RF signals and output only an out-of-phase wobble signal.

The output wobble signal may include a harmonic component due to the sensitivity unbalance of a photodiode or the unbalance of each channel. Accordingly, the output wobble signal is filtered by the BPF 150, which has a narrow band, so that the harmonic component is removed therefrom. Consequently, a signal to noise ratio (SNR) of the wobble signal increases. The output of the BPF 150 is input to the third AGC 160 and gain-amplified by the third AGC 160. Thereafter, the wobble signal is quantized by the comparator 170 and is output as a wobble clock signal WCS therefrom.

The wobble clock signal WCS is turned into a channel clock signal, which is necessary for data reading or writing, by a wobble PLL (not shown).

FIG. 2 is a table showing different types of discs and the wobble frequencies of each of the discs at various speeds. Referring to FIG. 2, wobble frequencies are different according to the types and speeds of discs. More specifically, as the speed of a disc increases, the wobble frequency fwb increases.

For example, at a 1×speed, the wobble frequency of a CD-R/RW is 22.05 kHz, the wobble frequency of a DVD-R/RW is 140.60 kHz, the wobble frequency of a DVD-RAM is 156.88 kHz, the wobble frequency of a DVD+R/RW is 817.50 kHz, the wobble frequency of a HD DVD-R/RW is 696.77 kHz, and the wobble frequency of a BD-R/RE is 956.52 kHz. When a wobble frequency is high as in HD DVD-R/RWs or BD-R/REs, the central frequency of the BPF included in a wobble signal reproducing apparatus increases. Accordingly, designing the BPF is difficult.

FIG. 3 is a table showing different center frequency characteristics of a BPF according to different types of discs. Referring to FIG. 3, the BPF has different center frequencies fc according to the type of disc. A BPF corresponding to CD-R/RWs, DVD-R/RWs, DVD-RAMs, DVD+R/RWs, and HD DVD-R/RWs has a sharp band. In other words, the BPF corresponding to CD-R/RWs, DVD-R/RWs, DVD-RAMs, DVD+R/RWs, and HD DVD-R/RWs has a relatively high quality factor. However, a BPF corresponding to BD-R/REs has a flat band. In other words, the BPF corresponding to BD-R/REs has a relatively low quality factor.

Since CD-R/RWs, DVD-R/RWs, DVD-RAMs, DVD+R/RWs, and HD DVD-R/RWs include only monotone wobbles fwb, the corresponding BPF has a sharp band. However, BD-R/REs includes a minimum shift keying (MSK) wobble with addressing information and a sawtooth wobble with addressing information as well as a monotone wobble fwb. The MSK wobble includes a frequency component 1.5*fwb corresponding to a frequency component 1.5 times greater than that of the monotone wobble fwb. The sawtooth wobble includes a frequency component 2*fwb corresponding to a frequency component twice greater than the monotone wobble fwb. In other words, because the BPF corresponding to BD-RIREs should pass not only the monotone wobble but also the MSK wobble and the sawtooth wobble, the BPF has a flat band.

Methods of reading and writing a disc are classified into a constant linear velocity (CLV) mode and a constant angular velocity (CAV) mode according to a spindle motor controlling technique. Generally, the CLV mode is used for low-speed discs and the CAV mode is used for high-speed discs. In the CLV mode, a spindle motor is controlled to be slower from the innermost circumference to the outermost circumference of a disc, wherein the frequency characteristics of the innermost and outermost circumferences are identical. Meanwhile, in the CAV mode, the speed of a spindle motor is controlled to be constant regardless of which area on a disc is accessed, and the frequency of the outermost circumference is 2.4 times higher than the innermost circumference. Accordingly, when a disc is driven using the CLV mode, the wobble frequency is constant. On the other hand, when a disc is driven using the CAV mode, the wobble frequency linearly increases from the innermost circumference to the outermost circumference. Therefore, the central frequency fc of the BPF is constant when a CLV mode is used, whereas the central frequency fc of the BPF linearly increases when a CAV mode is used.

When CD-R/RWs, DVD-R/RWs, DVD-RAMs, DVD+R/RWs, and HD DVD-R/RWs are driven using the CLV mode, the central frequency fc of the BPF is fwb regardless of which area on a disc is accessed. When CD-R/RWs, DVD-R/RWs, DVD-RAMs, DVD+R/RWs, and HD DVD-R/RWs are driven using a CAV mode, the central frequency fc of the BPF when the innermost circumference of the disc is accessed is fwb/2.4 (that is 2.4 time smaller than the value fwb of the central frequency fc of the BPF when the outermost circumference of the disc is accessed).

As described above, in the case of new format discs such as BDs, a conventional wobble signal reproducing apparatus generates a wobble signal having a high wobble frequency and a multi-frequency component. Thus, it is difficult to use the conventional wobble signal reproducing apparatus.

### SUMMARY OF THE INVENTION

Aspects of the present invention provide a wobble signal reproducing apparatus capable of changing a pass band of a wobble signal according to the type of disc, the speed thereof, or a driving mode for the disc.

Aspects of the present invention also provide a wobble signal reproducing method by which a pass band of a wobble signal can be changed according to the type of a disc, the speed thereof, or a driving mode for the disc.

According to an aspect of the present invention, there is provided an apparatus for reproducing a wobble signal, comprising: a first filter unit receiving a wobble signal obtained by reading a wobble from a disc and passing a first band including a monotone frequency set according to the type or speed of the disc so as to generate a first wobble output signal; a second filter unit, when the wobble signal includes at least one frequency component, receiving the wobble signal and passing a second band including a multi-frequency set according to the speed of the disc so as to generate a second wobble output signal; and a wobble clock signal generation unit generating a wobble clock signal by quantizing one of the first and second wobble output signals.

According to an aspect of the invention, the apparatus may further include a frequency correction unit for generating a correction signal for correcting the monotone frequency and the multi-frequency according to a driving mode for the disc and providing the correction signal to the first and second filter units.

According to an aspect of the invention, the frequency correction unit may include: a power supply unit; a location detection unit outputting a location signal that represents the location of a track on the disc; and a selection unit selecting the location signal of the location detection unit when the driving mode for the disc is a constant angular velocity (CAV) mode and selecting the power supply unit when the driving method for the disc is a constant linear velocity (CLV) mode.

According to an aspect of the invention, the apparatus may further include a wobble phase locked loop which receives the wobble clock signal and generates a channel clock signal.

According to an aspect of the invention, the apparatus may further include: a minimum shift keying (MSK) detection unit quantizing the second wobble output signal and detecting an MSK wobble having addressing information from the quantized second wobble output signal; and a sawtooth detection unit converting the second wobble output signal into a digital signal and detecting a sawtooth wobble from the digital signal, wherein when the disc is a Blu-ray disc (BD), the wobble signal comprises the MSK wobble and the sawtooth wobble.

According to an aspect of the invention, the first filter unit may include: a band pass filter (BPF) unit receiving the wobble signal and performing band-pass-filtering on the wobble signal with a monotone frequency; and an automatic gain controller (AGC) receiving and amplifying an output of the band pass filter unit so as to generate the first wobble output signal.

According to an aspect of the invention, the apparatus may further include a frequency divider dividing the frequency of the channel clock signal according to the speed of the disc and providing a switching signal having a predetermined frequency to the BPF unit.

According to an aspect of the invention, the BPF unit may include: a switched capacitor-band pass filter (SW-BPF) performing band pass filtering on the wobble signal with the monotone frequency that varies according to the disc type and the switching signal; and a smoothing low pass filter (LPF) receiving an output of the SW-BPF and performing low-pass-filtering on the output of the SW-BPF with a cut-off frequency that varies according to the speed of the disc and the correction signal.

According to an aspect of the invention, the BPF unit may include: a trans conductance capacitor (gm C) BPF performing band pass filtering on the wobble signal with the monotone frequency that varies according to the speed of the disc and the correction signal; and a tuning unit tuning an output of the gm-C band pass filter.

According to an aspect of the invention, the second filter unit may include: a BPF unit receiving the wobble signal and performing band-pass-filtering on the wobble signal with a second band including the multi-frequency; and an AGC receiving and amplifying an output of the band pass filter unit so as to generate second wobble output signal.

According to an aspect of the invention, the band pass filter unit may include: a high pass filter (HPF) receiving the wobble signal and performing high-pass-filtering on the wobble signal with a first cut-off frequency that is set according to the speed of the disc and a disc driving mode; and a low pass filter receiving an output of the high pass filter and performing low-pass-filtering on the output of the high pass filter with a second cut-off frequency that is set according to the speed of the disc and the disc driving mode.

According to another aspect of the present invention, there is provided a method of reproducing a wobble signal, including the operations of: receiving a wobble signal obtained by reading a wobble from a disc and passing a first band including a monotone frequency set according to the type or speed of the disc so as to generate a first wobble output signal; when the wobble signal includes at least one frequency component, receiving the wobble signal and passing a second band including a multi-frequency set according to the speed of the disc so as to generate a second wobble output signal; and generating a wobble clock signal by quantizing one of the first and second wobble output signals.

According to an aspect of invention, the method may further include the operation of generating a correction signal for correcting the monotone frequency and the multi-frequency according to a driving mode for the disc.

According to an aspect of the invention, the operation of generating the correction signal may include the suboperations of: outputting a location signal depending on the location of a track on the disc when the driving method for the disc is a CAV mode; and outputting a power supply voltage when the driving mode for the disc is a CLV mode.

According to an aspect of the invention, the method may further include the operation of receiving the wobble clock signal and generating a channel clock signal.

According to an aspect of the invention, the method may further include the operations of: quantizing the second wobble output signal and detecting an MSK (minimum shift keying) wobble having addressing information from the quantized second wobble output signal; and converting the second wobble output signal into a digital signal and detecting a sawtooth wobble from the digital signal, wherein when the disc is a Biu-ray disc (BD), the wobble signal comprises the MSK wobble and the sawtooth wobble.

According to an aspect of the invention, the operation of generating the first wobble output signal may include the sub-operations of: receiving the wobble signal and performing band-pass-filtering on the wobble signal by passing only the first band including the monotone frequency; and receiving and amplifying the band-pass-filtered wobble signal so as to generate the first wobble output signal.

According to an aspect of the invention, the operation of generating the second wobble output signal may include the sub-operations of: receiving the wobble signal and performing band-pass-filtering on the wobble signal by passing only the second band including the multi-frequency; and receiving and amplifying the band-pass-filtered wobble signal so as to generate the second wobble output signal.

According to another aspect of the present invention, there is provided a method of reproducing a wobble signal, including the operations of: receiving a wobble signal obtained by reading a wobble from a disc and setting a central frequency according to the type of the disc, the speed of the disc, or a driving mode for the disc; generating a wobble output signal by performing band-pass-filtering on the wobble signal on the basis of the set central frequency; generating a channel clock signal from the wobble clock signal; and detecting one of a minimum shift keying (MSK) wobble having addressing information and a sawtooth wobble from the wobble output signal when the disc is a Blu-ray disc (BD).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional wobble signal reproducing apparatus;

FIG. 2 is a table showing different types of discs and different wobble frequencies of each of the discs for different speeds;

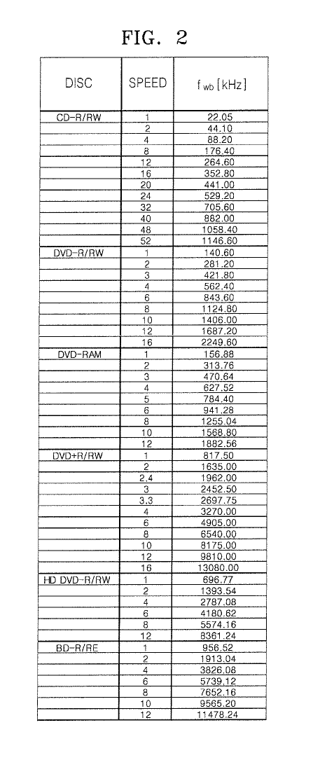

FIG. 3 is a table showing different center frequency characteristics of a band pass filter (BPF) for different types of discs;

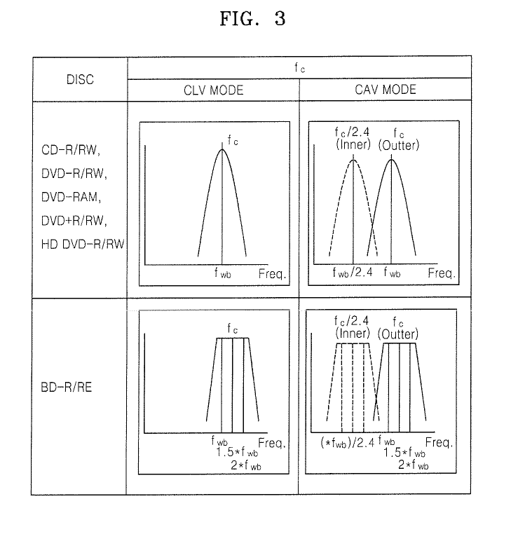

FIG. 4 is a block diagram of a wobble signal reproducing apparatus according to an embodiment of the present invention;

FIG. 5 is a block diagram of a detailed structure of the wobble signal reproducing apparatus illustrated in FIG. 4, according to an embodiment of the present invention;

FIG. 6 is a block diagram of a detailed structure of the wobble signal reproducing apparatus illustrated in FIG. 4, according to another embodiment of the present invention; and

FIG. 7 is a flowchart of a wobble signal reproducing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

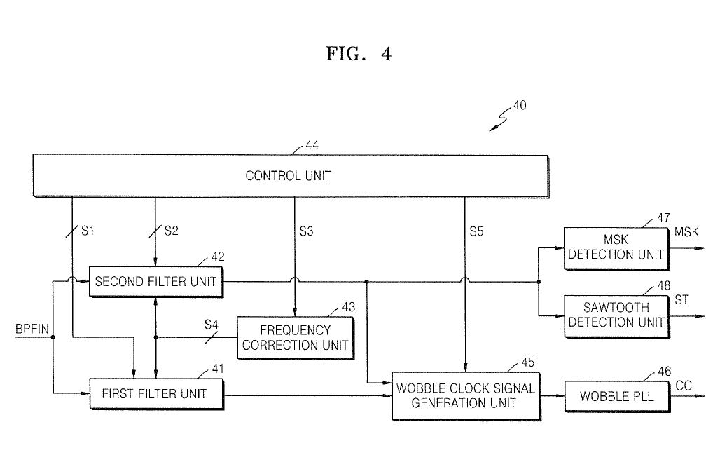

FIG. 4 is a block diagram of a wobble signal reproducing apparatus 40 according to an embodiment of the present invention. Referring to FIG. 4, the wobble signal reproducing apparatus 40 includes a first filter unit 41, a second filter unit 42, a frequency correction unit 43, a control unit 44, and a wobble clock signal generation unit 45. The wobble signal reproducing apparatus 40 further includes a wobble phase locked loop (PLL) 46, a minimum shift keying (MSK) detection unit 47, and a sawtooth detection unit 48. While not required in all aspects, the wobble signal reproducing apparatus 40 can be included in a recording and/or reproducing apparatus usable with a medium or media having wobbles in addition to or instead of media not using wobbles. Further, the wobble signal reproducing apparatus 40 can be included in a recording and/or reproducing apparatus compatible with combinations of CD-R, CD-RW, DVD-R, DVD-RN/, DVD-RAM, DVD+R, DVD+RW, HD-DVD-R, HD-DVD-RW, BD-R, and BD-RE. Such a compatible recording and/or reproducing apparatus can include an optical pickup controlled by a controller, such as the control unit 44, to recording and/or reproduce data with respect to one of a plurality of optical media using the detected clock signal detected using the wobble signal reproducing apparatus 40.

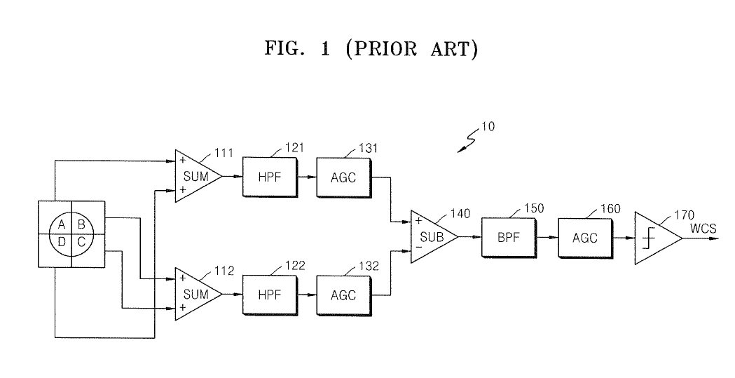

The wobble signal reproducing apparatus 40 receives a wobble signal BPFIN which is obtained by reading a wobble from a disc (e.g., received through a photo detector like that shown in FIG. 1). The wobble signal BPFIN is input to the first and second filter units 41 and 42, but the present invention is not limited thereto. For example, the wobble signal BPFIN may be input to only one of the first filter unit 41 and the second filter unit 42. More specifically, depending on the type of disc, the wobble signal BPFIN may be selectively input to either the first filter unit 41 without being input to the second filter unit 42, or input to the second filter unit 42 without being input to the first filter unit 41. The first and second filter units 41 and 42 remove a harmonic component that has been included due to the sensitivity unbalance of a photodiode (which is a light-receiving device such as the photo detector shown in FIG. 1), and the unbalance of each channel while the wobble signal BPFIN is being read from the disc, thereby generating a pure wobble output signal.

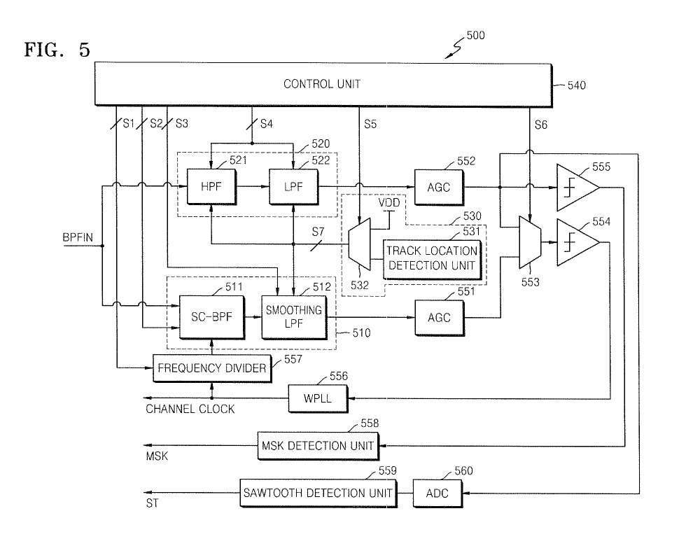

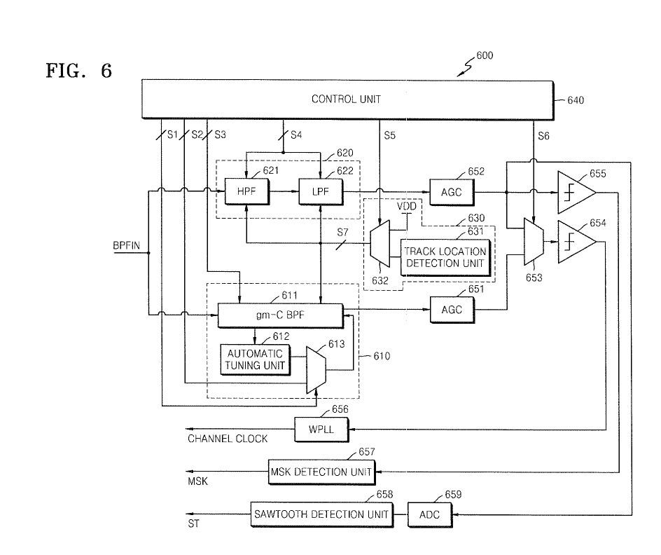

The frequency correction unit 43 receives a disc-driving method selection signal S3 representing whether a disc-driving method is a constant linear velocity (CLV) mode or a constant angular velocity (CAV) mode, from the control unit 44. The frequency connection unit 43 generates a correction signal S4 on the basis of the disc-driving method selection signal S3, and provides the correction signal S4 to the first and second filter units 41 and 42. A detailed operation of the frequency correction unit 43 will be described later with reference to FIGS. 5 and 6.

The first filter unit 41 receives the wobble signal BPFIN and passes a first band including a monotone frequency set according to the type and speed of a disc, thereby generating a first wobble output signal. More specifically, the first filter unit 41 performs band-pass-filtering according to a monotone frequency that is set according to a disc-type or disc-speed selection signal S1 received from the control unit 44. The monotone frequency set according to the disc-type or disc-speed selection signal S1 is corrected according to the correction signal S4 received from the frequency correction unit 43, as needed.

The second filter unit 42 receives the wobble signal BPFIN. When the wobble signal BPFIN includes at least one frequency component, the second filter unit 42 passes a second band including a multi-frequency that is set according to the speed of a disc, thereby generating a second wobble output signal. More specifically, the second filter unit 42 performs band-pass-filtering according to a multi-frequency set according to a disc speed selection signal S2 received from the control unit 44. The multi-frequency set according to the disc multi-speed selection signal S2 is corrected according to the correction signal S4 received from the frequency correction unit 43, as needed.

As described above, discs such as CDs, DVDs, and HD DVDs include only monotone wobbles. In contrast, BDs include not only monotone wobbles, but also MSK wobbles including addressing information and saw-tooth wobbles, which also include addressing information. The frequency components of a monotone wobble, an MSK wobble, and a sawtooth wobble will now be described with reference to Equations 1 through 3:

MW=cos{2π*(fwb)*t} (1)

MW denotes a monotone wobble, and fwb denotes a monotone wobble frequency. According to Equation 1, the monotone wobble MW includes only the monotone wobble frequency fwb.

Equation 2 is as follows:

MSK Wobble=MW+cos{2*(1.5*fwb)*t} (2)

MSK Wobble denotes an MSK wobble, MW denotes the monotone wobble, and fwb denotes the monotone wobble frequency. According to Equation 2, the MSK wobble includes not only the monotone wobble frequency fwb, but also a frequency 1.5*fwb (that is, the MSK wobble includes two frequency components).

Equation 3 is as follows:

STW Wobble=MW±a*sin{2π*(2*fwb)*t} (3)

STW Wobble denotes a sawtooth wobble. MW denotes the monotone wobble. fwb denotes the monotone wobble frequency. According to Equation 3, the sawtooth wobble includes not only the monotone wobble frequency fwb, but also a frequency 2*fwb (that is, the sawtooth wobble includes two frequency components).

The first filter unit 41 may receive a wobble signal read from a CD, a DVD, an HD DVD, or a BD. However, since the first filter unit 41 band-pass-filters only a monotone frequency component, even when a received wobble signal includes a variety of frequency components like a wobble signal read from a BD, the first filter unit 41 passes only a monotone frequency component. In other words, the first filter unit 41 provides a high quality factor. On the other hand, the second filter unit 42 may receive a wobble signal read from a CD, a DVD, an HD DVD, or a BD, but passes a multi-frequency component, thus providing a low quality factor.

When a wobble signal having only a monotone frequency (such as, a wobble signal read from a CD, a DVD, or an HD DVD) is input to the first and second filter units 41 and 42, the first wobble output signal output from the first filter unit 41 may be selected to generate a wobble clock signal. In this case, when a wobble signal having only a monotone frequency (such as, a wobble signal read from a CD, a DVD, or an HD DVD) is input to the first and second filter units 41 and 42, the second filter unit 42 may be turned off.

In contrast, when a wobble signal having a multi-frequency (such as, a wobble signal read from a BD) is input to the first and second filter units 41 and 42, the first filter unit 41 passes only a monotone wobble frequency, and the second filter unit 42 passes a monotone wobble frequency, an MSK wobble frequency, and a sawtooth wobble frequency. Accordingly, in order to detect an MSK wobble or a sawtooth wobble, the second wobble output signal, which is output by the second filter unit 42, should be used. If the second wobble output signal of the second filter unit 42 is used to detect a monotone wobble, a clock jitter may become serious because the second wobble output signal includes not only a monotone frequency component but also the other frequency components. Thus, in order to detect the monotone wobble included in the wobble signal having the multi-frequency, the first wobble output signal, which is output by the first filter unit 41, is preferably used in order to generate a wobble clock signal from the detected monotone wobble.

The shown control unit 44 includes a plurality of registers, and provides selection signals for controlling the blocks included in the wobble signal reproducing apparatus 40. More specifically, the control unit 44 may generate the disc-type or disc-speed selection signal S1 for controlling the first filter unit 41, the disc speed selection signal S2 for controlling the second filter unit 42, the disc-driving method selection signal S3 for controlling the frequency correction unit 43, and a selection signal S5 for controlling the wobble clock signal generation unit 45. However, it is understood that the control unit 44 can be otherwise constructed and can generate other signals, such as signals, such as signals to record and/or reproduce data with respect to the disc.

The wobble clock signal generation unit 45 receives the first and second wobble output signals from the first and second filter units 41 and 42, selects one of the first and second wobble output signals according to the selection signal S5 received from the control unit 44, and quantizes the selected signal to thereby generate the wobble clock signal. In some embodiments, the wobble clock signal generation unit 45 may include a selector and a The wobble PLL 46 receives the wobble clock signal generated by the wobble clock signal generation unit 45 and generates a channel clock signal CC synchronized with the wobble clock signal. The channel clock signal CC is used when data is read from or written to a disc.

The MSK detection unit 47 receives and quantizes the second wobble output signal output by the second filter unit 42 to thereby detect an MSK component MSK. The sawtooth detection unit 48 receives and digitizes the second wobble output signal of the second filter unit 42 to thereby detect a sawtooth component ST.

As described above, the wobble signal reproducing apparatus 40 receives the wobble signal BPFIN and outputs the channel clock signal CC via the wobble PLL 46. When the wobble signal BPFIN includes multiple frequency components like a wobble signal read from a BD, the wobble signal reproducing apparatus 40 outputs the channel clock signal CC via the wobble PLL 46, outputs the MSK component MSK via the MSK detection unit 47, and outputs the sawtooth component ST via the sawtooth detection unit 48.

FIG. 5 is a block diagram of a detailed structure (hereinafter, referred to as a wobble signal reproducing apparatus 500) of the wobble signal reproducing apparatus 40 illustrated in FIG. 4, according to an embodiment of the present invention. Referring to FIG. 5, the wobble signal reproducing apparatus 500 includes a first band pass filter (BPF) unit 510, a second BPF unit 520, a frequency correction unit 530, and a control unit 540. The wobble signal reproducing apparatus 500 further includes a first automatic gain controller (AGC) 551, a second AGC 552, a first selection unit 553, a first comparison unit 554, and a second comparison unit 555. The wobble signal reproducing apparatus 500 further includes a wobble phase locked loop (WPLL) 556, a frequency divider 557, an MSK detection unit 558, a sawtooth detection unit 559, and an analog-to-digital converter (ADC) 560.

The first BPF unit 510 includes a switch capacitor-BPF (SC-BPF) 511 and a smoothing low pass filter (LPF) 512.

The SC-BPF 511 receives a wobble signal BPFIN, which is obtained by reading a wobble from a disc, and performs band pass filtering on the wobble signal BPFIN. The central frequency of a pass band of the SC-BPF 511 is calculated using Equation 4:

fc=1/(2π*Req*C2)=(fsw/2π)*(C1/C2) (4)

fc denotes a central frequency, Req denotes an equivalent resistance, fsw denotes a clock which is a switching frequency, and C1 and C2 denote internal capacitor values. In other words, the central frequency fc of the pass band of the SC-BPF 511 is proportional to the switching frequency fsw and varies according to the internal capacitor values C1 and C2.

First, regarding a change in the pass band of the SC-BPF 511 depending on the type of disc, the SC-BPF 511 may receive an n-bit disc selection signal S2 from the control unit 540 and change the value of an internal device such as a capacitor according to the n-bit disc selection signal S2 to thereby change the center frequency fc.

Next, regarding a change in the pass band of the SC-BPF 511 depending on the multi-speed of the disc, the frequency divider 557 receives an n-bit disc speed selection signal S1 from the control unit 540 and frequency-divides a channel clock signal received from the WPLL 556 according to the disc speed selection signal S1, thereby generating a switching signal fsw with a predetermined frequency and outputting the switching signal fsw to the SC-BPF 511. Accordingly, the SC-BPF 511 can change the central frequency fc by using the switching signal fsw controlled according to the speed of the disc.

Lastly, regarding a change in the pass band of the SC-BPF 511 depending on a disc driving method, when the disc driving method is a CLV mode, a frequency is constant regardless of the location of a track on the disc, and thus the switching signal fsw has a fixed value. On the other hand, when the disc driving method is a CAV mode, a frequency varies according to the location of a track on the disc. A frequency in the outermost circumference of the track is 2.4 times greater than that in the innermost circumference thereof. Thus, in this case, the frequency of the switching signal fsw is also changed according to the location of a track on the disc and provided to the SC-BPF 511.

Even when the wobble signal reproducing apparatus 500 receives a wobble signal from a new format disc such as a BD, the wobble signal from the new format disc may be easily handled by controlling the value of an internal device included in the first filter unit 510.

The smoothing LPF 512 receives the output of the SC-BPF 511 and performs low pass filtering thereon. Since the output of the SC-BPF 511 is discrete, the smoothing LPF 512 is used to make the discrete value indiscrete. The smoothing LPF 512 has a cut-off frequency that varies according to the type of disc and a disc driving method.

First, regarding a change in the cut-off frequency of the smoothing LPF 512 depending on the speed of a disc, the smoothing LPF 512 receives an n-bit disc speed selection signal S3 from the control unit 540 and changes the value of an internal device such as a resistor. The change of the internal device value causes the cut-off frequency to be changed.

Next, regarding a change in the cut-off frequency of the smoothing LPF 512 depending on the disc driving method, the frequency correction unit 530 includes a track location detection unit 531 and a second selection unit 532. When the disc driving method is a CLV mode, a frequency is constant regardless of the location of a track on the disc. On the other hand, when the disc driving method is a CAV mode, a frequency varies according to the location of a track on the disc. The track location detection unit 531 generates an n-bit location signal according to the location of a track on the disc. More specifically, the output signal of the track location detection unit 531 is a series of binary ‘1’s when an area on the disc being accessed is the outermost circumference, and a series of binary ‘0’s when the area on the disc being accessed is the innermost circumference. The frequency for the CLV mode is constant, and its value is equal to the frequency of the outermost circumference for the CAV mode. Thus, when the disc driving method is a CLV mode, the smoothing LPF 512 receives a signal of a series of binary ‘1’s from a VDD power supply. The second selection unit 532 receives a disc-driving method selection signal S5 from the control unit 540, and selects a VDD voltage received from the VDD power supply when the disc driving method is a CLV mode and selects an output of the track location detection unit 531 when the disc driving method is a CAV mode. The selection unit 532 outputs an n-bit correction signal S7 to the smoothing LPF 512. According to the received correction signal S7, the value of an internal device, such as a capacitor, included in the smoothing LPF 512 is changed, and the cut-off frequency thereof is accordingly changed.

The second BPF unit 520 includes a high pass filter (HPF) 521 and an LPF 522. The second BPF unit 520 may receive a wobble signal BPFIN having a multi-frequency component. For example, the second BPF unit 520 may receive a wobble signal from a BD and perform band pass filtering on the wobble signal so as to pass a band with a multi-frequency component. The wobble signal described below is a wobble signal read from a BD.

The HPF 521 receives a wobble signal BPFIN and high-pass filters the wobble signal BPFIN. The HPF 521 also receives the n-bit disc speed selection signal S4 from the control unit 540. The value of an internal device, such as a resistor, included in the HPF 521 is changed according to the disc speed selection signal S4, and the cut-off frequency thereof is accordingly changed. The HPF 521 also receives the n-bit correction signal S7 from the frequency correction unit 530 and changes the value of its internal device, such as a capacitor, according to the correction signal S7 to thereby change the cut-off frequency. In other words, the HPF 521 high-pass filters the wobble signal BPFIN according to the cut-off frequency set according to the disc speed selection signal S4 and the correction signal S7.

The LPF 522 receives the output of the HPF 521 and low-pass filters the received signal according to a cut-off frequency. The LPF 522 receives the n-bit disc speed selection signal S4 from the control unit 540 and changes the value of an internal device, such as a resistor, according to the disc speed selection signal S4, thereby changing the cut-off frequency. The LPF 522 receives the n-bit correction signal S7 from the frequency correction unit 530 and changes the value of an internal device, such as a capacitor, according to the correction signal S7, thereby changing the cut-off frequency. The LPF 522 low-pass filters the output of the HPF 521 according to the cut-off frequency set according to the disc speed selection signal S4 and the correction signal S7.

As described above, the second BPF unit 520 includes the HPF 521 and the LPF 522 so as to perform band pass filtering on the received wobble signal BPFIN according to a band set according to a disc speed and a disc-driving method.

The shown control unit 540 includes a plurality of registers and provides selection signals for controlling the blocks included in the wobble signal reproducing apparatus 500. More specifically, the control unit 540 selectively generates the disc speed selection signal S1 for controlling the frequency divider 557, the disc selection signal S2 for controlling the SC-BPF 511, the disc speed selection signal S3 for controlling the smoothing LPF 512, and the disc speed selection signal S4 for controlling the second BPF unit 520. The control unit 540 selectively also generates the disc-driving method selection signal S5 for controlling the second selection unit 532 and a selection signal S6 for controlling the first selection unit 553.

The first and second AGCs 551 and 552 receive and amplify the outputs of the first and second BPF units 510 and 520, respectively. The first selection unit 553 selects and outputs one of the outputs of the first and second AGCs 551 and 552 according to the selection signal S6 received from the control unit 540. When the wobble signal reproducing apparatus 500 receives a wobble signal with a monotone frequency such as a wobble signal read from a CD, a DVD, or an HD DVD, the first selection unit 553 selects the output of the first AGC 551. When the wobble signal reproducing apparatus 500 receives a wobble signal with a multi-frequency such as a wobble signal read from a BD, the first selection unit 553 selects any one of the outputs of the first and second AGCs 551 and 552. However, in order to generate a channel clock signal in consideration of a clock jitter and so on, it is generally preferable that the output of the first AGC 551 is selected.

The first comparison unit 554 receives and quantizes the output of the first selection unit 553 to generate a wobble clock signal, and outputs the wobble clock signal to the WPLL 556. The second comparison unit 555 receives and quantizes the output of the second AGC 552 and provides the result of the quantization to the MSK detection unit 558.

The WPLL 556 receives the wobble clock signal from the first comparison unit 554 and generates a channel clock signal synchronized with the wobble clock signal. The frequency divider 557 receives the channel clock signal from the WPLL 556, frequency-divides the channel clock signal according to the n-bit disc speed selection signal S1 received from the control unit 540, and provides a switching signal fsw to the SC-BPF 511.

As described above, when a BD is used, a wobble signal read from the BD includes not only a monotone wobble but also an MSK wobble MSK having addressing information and a sawtooth wobble ST. Therefore, special blocks are needed to detect the MSK wobble MSK and the sawtooth wobble ST. The MSK detection unit 558 detects the MSK wobble MSK having addressing information from the output of the second comparison unit 555. The ADC 560 receives the output of the second AGC 552 and converts it into a digital signal. The sawtooth detection unit 559 detects the sawtooth wobble ST from the output of the second AGC 552.

However, it is apparent to one of ordinary skill in the art that even when a wobble signal is obtained from a new-format disc including a multi-frequency component other than a BD, special blocks for detecting different frequency components may be connected to the second AGC 552 and receive an output of the second AGC 552.

FIG. 6 is a block diagram of a detailed structure (hereinafter, referred to as a wobble signal reproducing apparatus 600) of the wobble signal reproducing apparatus 40 illustrated in FIG. 4, according to another embodiment of the present invention. Referring to FIG. 6, the wobble signal reproducing apparatus 600 includes a first BPF unit 610, a second BPF unit 620, a frequency correction unit 630, and a control unit 640. The wobble signal reproducing apparatus 600 further includes a first AGC 651, a second AGC 652, a first selection unit 653, a first comparison unit 654, and a second comparison unit 655. The wobble signal reproducing apparatus 600 further includes a WPLL 656, an MSK detection unit 657, a sawtooth detection unit 658, and an ADC 659.

The first BPF unit 610 includes a trans conductance capacitor BPF (hereinafter, referred to as a gm-C BPF) 611, an automatic tuning unit 612, and a tuning selection unit 613. The automatic tuning unit 612 may be included in the gm-C BPF 611, but need not in all aspects.

The gm-C BPF 611 receives a wobble signal BPFIN obtained by reading a wobble from a disc, and performs band pass filtering on the wobble signal BPFIN. The central frequency fc of the pass band of the gm-C BPF 611 is proportional to a trans conductance gm, which is a ratio of an output current to an input voltage, and is inversely proportional to the value of a capacitor included in the gm-C BPF 611. Accordingly, the central frequency fc can vary by controlling the trans conductance and the capacitor value.

First, regarding a change in the pass band of the gm-C BPF 611 depending on the speed of a disc, the gm-C BPF 611 receives an n-bit disc speed selection signal S3 from the control unit 640 and changes an internal device value, such as a trans conductance gm, according to the n-bit disc speed selection signal S3 to thereby change the central frequency fc. The gm-C BPF 611 provides consecutive outputs and can obtain a desired central frequency fc according to the value of the trans conductance gm. Accordingly, the central frequency fc can be changed by receiving the n-bit disc speed selection signal S3 rather than a special disc selection signal and controlling the trans conductance gm according to the n-bit disc speed selection signal S3.

Next, regarding a change in the pass band of the gm-C BPF 611 depending on the disc driving method, the frequency correction unit 630 includes a track location detection unit 631 and a second selection unit 632. When the disc driving method is a CLV mode, a frequency is constant regardless of the location of a track on the disc. However, when the disc driving method is a CAV mode, a frequency varies according to the location of a track on the disc. The track location detection unit 631 generates an n-bit location signal according to the location of a track on the disc. More specifically, the output signal of the track location detection unit 631 is a series of binary ‘1’s when an area on the disc being accessed is the outermost circumference, and a series of binary ‘0’s when the area on the disc being accessed is the innermost circumference. The frequency for the CLV mode is constant, and its value is equal to the frequency of the outermost circumference for the CAV mode. Thus, when the disc driving method is a CLV mode, the gm-C BPF 611 receives a signal of a series of binary ‘l’s from a VDD power supply VDD. The second selection unit 632 receives a disc-driving method selection signal S5 from the control unit 640, and selects a VDD voltage received from the VDD power supply when the disc driving method is a CLV mode and selects an output of the track location detection unit 631 when the disc driving method is a CAV mode. The selection unit 632 outputs an n-bit correction signal S7 to the gm-C BPF 611. According to the received correction signal S7, the gm-C BPF 611 changes the value of an internal device, such as, a capacitor, included therein to thereby change the central frequency fc.

Since the gm-C BPF 611 provides consecutive outputs, the first BPF unit 610 does not need to include a special smoothing LPF, like the LPF 512 shown in the embodiment of FIG. 5. Generally, the SC-BPF 511 uses a clock and thus cannot be used for high-speed discs, whereas the gm-C BPF 611 does not use a clock and thus can be easily used for high-speed discs. However, the gm-C BPF 611 is generally not as accurate as the SC-BPF 511, and thus an automatic tuning unit 612 is included after the gm-C BPF 611.

The tuning selection unit 613 receives from the control unit 640 a signal S2 for manually correcting the central frequency fc of the gm-C BPF 611 according to output frequency characteristics, and also receives the output of the automatic tuning unit 612. The tuning selection unit 613 receives an n-bit tuning selection signal S1 from the control unit 640 and selects one of the signal S2 received from the control unit 640 and the output of the automatic tuning unit 612 so as to correct the central frequency fc of the gm-C BPF 611.

As described above, the central frequency fc of the gm-C BPF 611 is changed according to the multi-speed of a disc and a disc driving method, and a wobble signal is band-pass-filtered according to the changed central frequency fc. Even when the wobble signal reproducing apparatus 600 receives a wobble signal from a new-format disc such as a BD, the central frequency fc may be easily changed by controlling the trans conductance gm of the first BPF unit 610.

The second BPF unit 620 includes an HPF 621 and an LPF 622. The second BPF unit 620 may receive a wobble signal BPFIN having a multi-frequency component. For example, the second BPF unit 620 may receive a wobble signal from a BD and performs band pass filtering on the wobble signal so as to pass a band including the multi-frequency component. A wobble signal described below is a wobble signal read from a BD.

The HPF 621 receives the wobble signal BPFIN and high-pass filters the wobble signal BPFIN. The HPF 621 receives an n-bit disc speed selection signal S4 from the control unit 640 and changes the value of an internal device, such as a resistor, included therein according to the disc speed selection signal S4, thereby changing a cut-off frequency. The HPF 621 also receives an n-bit correction signal S7 from the frequency correction unit 630 and changes the value of its internal device, such as a capacitor, according to the correction signal S7, thereby changing the cut-off frequency. The HPF 621 high-pass filters the wobble signal BPFIN according to the cut-off frequency set according to the disc speed selection signal S4 and the correction signal S7.

The LPF 622 receives the output of the HPF 621 and low-pass filters the received signal according to a cut-off frequency. The LPF 622 receives the n-bit disc speed selection signal S4 from the control unit 640 and changes the value of an internal device, such as a resistor, according to the disc speed selection signal S4, thereby changing the cut-off frequency. The LPF 622 receives the n-bit correction signal S7 from the frequency correction unit 630 and changes the value of an internal device, such as a capacitor, according to the correction signal S7, thereby changing the cut-off frequency. In other words, the LPF 622 low-pass filters on the output of the HPF 621 according to the cut-off frequency set according to the disc speed selection signal S4 and the correction signal S7.

As described above, the second BPF unit 620 includes the HPF 621 and the LPF 622 so as to perform band pass filtering on the received wobble signal BPFIN according to a band set according to a disc speed and a disc-driving method.

The shown control unit 640 includes a plurality of registers and provides selection signals for controlling the blocks included in the wobble signal reproducing apparatus 600. More specifically, the control unit 640 selectively generates the disc speed selection signal S1 for controlling the tuning selection unit 613, the signal S2 for manually controlling the gm-C BPF 611, the disc speed selection signal S3 for controlling the gm-C BPF 611, and the disc speed selection signal S4 for controlling the second BPF unit 620. The control unit 640 also selectively generates the disc-driving method selection signal S5 for controlling the second selection unit 632 and a selection signal S6 for controlling the first selection unit 653.

The functions and structure of the first and second AGCs 651 and 652, the selection unit 653, the first and second comparison units 654 and 655, the WPLL 656, the MSK detection unit 657, the ADC 659, and the sawtooth detection unit 658 are substantially the same as those of the wobble signal reproducing apparatus 500 illustrated in FIG. 5, so detailed descriptions thereof will be omitted.

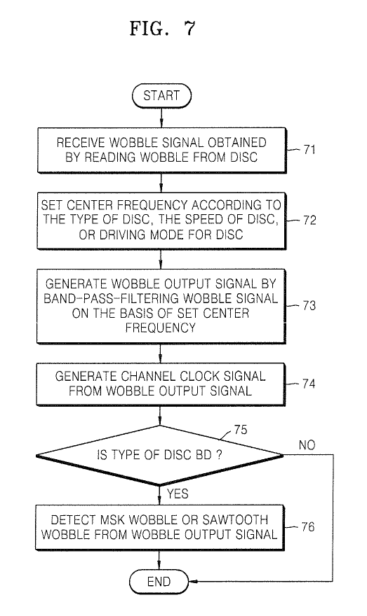

FIG. 7 is a flowchart of a wobble signal reproducing method according to an embodiment of the present invention. Referring to FIG. 7, in operation 71, a wobble signal is received which is obtained by reading a wobble from a disc is received. The wobble signal includes a variety of frequencies according to the type of a disc, the speed thereof, or a driving mode therefor. Depending on the type of disc, the wobble signal may include not only a monotone wobble, but also other frequency wobbles.

In operation 72, a center frequency of a filter unit is set according to the type of disc, the speed of a disc, or a driving mode for the disc. In operation 73, a wobble output signal is generated by band pass filtering the wobble signal on the basis of the set center frequency. Since the received wobble signal may include a harmonic component because of, for example, an unbalance between channels, a pure wobble output signal should be generated by performing band-pass-filtering.

In operation 74, a channel clock signal is generated from the wobble output signal. More specifically, a channel clock signal is generated that is synchronized with the wobble clock signal. The channel clock signal is used when data is read from or written to a disc.

In operation 75, it is determined whether the type of disc is a BD. If it is determined that the used disc is not a BD, the method is concluded. However, if it is determined that the used disc is a BD, an MSK wobble and a sawtooth wobble are detected from the wobble output signal, in operation 76. In contrast with wobble signals read from CDs, DVDs, HD DVDs, etc., a wobble signal read from a BD includes an MSK wobble and a sawtooth wobble as well as a monotone frequency component. Thus, detection of the MSK wobble or the sawtooth wobble is necessary. However, while described in terms of a BD type disc having two types of non-monotone frequency components (i.e., the MSK wobble and the sawtooth wobble), other types of media can have other numbers of non-monotone frequency components needing to be detected such that fewer or more than two types of non-monotone frequency components need be detected.

As described above, in a wobble signal reproducing apparatus and method according to the present invention, even a wobble signal from a new format disc can be detected by appropriately controlling the center frequency of a band pass filter according to the type of disc, the speed of a disc, or a driving mode for the disc.

Moreover, due to the inclusion of two filters, even when a wobble signal having a variety of frequency components is received, each of the frequency components can be detected. Thus, a wobble signal from a new format disc can be divided in accordance with its purpose of use and then used.

While not required in all aspects, it is understood that aspects of the invention can be implemented as computer software and/or firmware encoded on a computer readable media and which is implemented on one or more computers and/or processors.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for reproducing a wobble signal, comprising:
a first filter unit to receive a wobble signal obtained by reading a wobble from a disc and passing a first band including a monotone frequency adjusted according to a type or a speed of the disc having the wobble so as to generate a first wobble output signal;
a second filter unit, when the wobble signal includes at least one frequency component, to receive the wobble signal and passing a second band including a multi-frequency adjusted according to the speed of the disc so as to generate a second wobble output signal; and
a wobble clock signal generation unit to quantize one of the first and second wobble output signals to generate a wobble clock signal.

2. The apparatus of claim 1, further comprising a frequency correction unit to generate a correction signal for correcting the adjusted monotone frequency and the multi-frequency according to a driving mode for the disc and to provide the correction signal to the first and second filter units to correct the adjusted monotone frequency and the multi-frequency.

3. The apparatus of claim 2, wherein the frequency correction unit comprises:
a power supply unit to supply a voltage;
a location detection unit to output a location signal that represents the location of a track on the disc; and
a selection unit to select the location signal of the location detection unit when the driving mode for the disc is a constant angular velocity (CAV) mode and to select the voltage supplied by the power supply unit when the driving method for the disc is a constant linear velocity (CLV) mode.

4. The apparatus of claim 3, further comprising a wobble phase locked loop to receive the wobble clock signal and to generate a channel clock signal according to the received wobble clock signal.

5. The apparatus of claim 4, further comprising:
a minimum shift keying (MSK) detection unit to quantize the second wobble output signal and to detect an MSK wobble having addressing information from the quantized second wobble output signal; and
a sawtooth detection unit to convert the second wobble output signal into a digital signal and to detect a sawtooth wobble from the digital signal,
wherein, when the disc is a Blu-ray disc (BD), the wobble signal comprises at least the MSK wobble and the sawtooth wobble.

6. The apparatus of claim 4, wherein the first filter unit comprises:
a band pass filter unit to receive the wobble signal and to band-pass-filter the wobble signal with the adjusted monotone frequency; and
an automatic gain controller to receive and amplify an output of the band pass filter unit so as to generate the first wobble output signal.

7. The apparatus of claim 6, further comprising a frequency divider to divide a frequency of the channel clock signal according to the speed of the disc and to provide a switching signal having a predetermined frequency to the band pass filter unit.

8. The apparatus of claim 7, wherein the BPF unit comprises:
a switched capacitor-band pass filter (SW-BPF) to band pass filter the wobble signal with the monotone frequency that varies according to the disc type and the switching signal; and
a smoothing low pass filter to receive an output of the SW-BPF and to low-pass-filter the output of the SW-BPF with a cut-off frequency that varies according to the speed of the disc and the correction signal.

9. The apparatus of claim 6, wherein the band pass filter unit comprises:
a trans conductance capacitor (gm C) band pass filter to band pass filter on the wobble signal with the monotone frequency that varies according to the speed of the disc and the correction signal; and
a tuning unit to tune an output of the gm-C band pass filter.

10. The apparatus of claim 4, wherein the second filter unit comprises:
a band pass filter unit to receive the wobble signal and to band-pass-filter the wobble signal with a second band including the adjusted multi-frequency; and
an automatic gain controller to receive and amplify an output of the band pass filter unit so as to generate the second wobble output signal.

11. The apparatus of claim 10, wherein the band pass filter unit comprises:
a high pass filter to receive the wobble signal and to high-pass-filter the wobble signal with a first cut-off frequency that is adjusted according to the speed of the disc and a disc driving mode; and
a low pass filter to receive an output of the high pass filter and to low-pass-filter the output of the high pass filter with a second cut-off frequency that is adjusted according to the speed of the disc and the disc driving mode.

12. A method of reproducing a wobble signal, comprising:
receiving a wobble signal obtained by reading a wobble from a disc;
passing a first band including a monotone frequency adjusted according to a type or speed of the disc so as to generate a first wobble output signal from the received wobble signal;
when the received wobble signal includes at least one frequency component, passing a second band including a multi-frequency adjusted according to the speed of the disc so as to generate a second wobble output signal from the received; and
generating a wobble clock signal by quantizing one of the first and second wobble output signals.

13. The method of claim 12, further comprising generating a correction signal for correcting the adjusted monotone frequency and the adjusted multi-frequency according to a driving mode for the disc.

14. The method of claim 13, wherein the generating of the correction signal comprises:
outputting a location signal depending on a location of a track on the disc when the driving method for the disc is a constant angular velocity (CAV) mode; and
outputting a power supply voltage when the driving mode for the disc is a constant linear velocity (CLV) mode.

15. The method of claim 14, further comprising receiving the wobble clock signal and generating a channel clock signal from the received wobble signal.

16. The method of claim 15, further comprising:
quantizing the second wobble output signal and detecting a minimum shift keying (MSK) wobble having addressing information from the quantized second wobble output signal; and
converting the second wobble output signal into a digital signal and detecting a sawtooth wobble from the digital signal,
wherein when the disc is a Blu-ray disc (BD), the wobble signal comprises the MSK wobble and the sawtooth wobble.

17. The method of claim 15, wherein the generating of the first wobble output signal comprises:
receiving the wobble signal and performing band-pass-filtering on the wobble signal by passing only the first band including the adjusted monotone frequency; and
receiving and amplifying the band-pass-filtered wobble signal so as to generate the first wobble output signal.

18. The method of claim 15, wherein the generating of the second wobble output signal comprises:
receiving the wobble signal and performing band-pass-filtering on the wobble signal by passing only the second band including the adjusted multi-frequency; and
receiving and amplifying the band-pass-filtered wobble signal so as to generate the second wobble output signal.

19. A method of reproducing a wobble signal, comprising:
receiving a wobble signal obtained by reading a wobble from a disc and setting a central frequency according to a type of the disc, the speed of the disc, or a driving mode for the disc;
generating a wobble output signal by performing band-pass-filtering on the wobble signal on the basis of the set central frequency;
generating a channel clock signal from the wobble clock signal; and
detecting one of a minimum shift keying (MSK) wobble having addressing information and a sawtooth wobble from the wobble output signal when the disc is a Blu-ray disc (BD).

20. An apparatus for recording and/or reproducing data with respect to a disc according to a clock signal, comprising:
a control unit to detect a type of disc being used by the apparatus and which is selectable between a monotone wobble type and a non-monotone wobble type, to selectively generate a speed signal selectable between different data transfer speeds, and to selectively generate a monotone wobble type disc signal selectable between a plurality of monotone wobble type disc types of differing recording capacities;
a photodiode to transfer the data with respect to the disc and to output a wobble signal obtained by reading a wobble from a disc;
a first filter unit to pass a first band of the output wobble signal including a monotone frequency adjusted according to the generated speed signal and/or the generated monotone wobble type disc signal so as to generate a first wobble output signal;
a second filter unit to, when the control unit detects the disc to be the non-monotone wobble type disc, pass a second band of the output wobble signal including a multi-frequency adjusted according to the generated speed signal so as to generate a second wobble output signal; and
a clock signal generation unit to generate the clock signal by quantizing one of the generated first and second wobble output signals.
